(19) United States
(12) Patent Application Publication
(10) Pub. No.: US 2008/0008854 A1
(43) Pub. Date: Jan. 10, 2008

(54) Composite sheet, machining method for composite sheet and laser machining apparatus

(75) Inventors: Kunio Arai, Ebina-shi (JP); Tadashi Matsumoto, Ebina-shi (JP); Hiromi Nishiyama, Ebina-shi (JP); Kazuhisa Ishii, Ebina-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Via Mechanics, Ltd., Ebina-shi (JP)

(21) Appl. No.: 11/808,248

(22) Filed: Jun. 7, 2007

(30) Foreign Application Priority Data
Jun. 8, 2006 (JP) 2006-160351
Jun. 5, 2007 (JP) 2007-149531

(51) Int. Cl. B32B 3/10; B23K 26/00; B29C 35/08

(52) U.S. Cl. 428/135; 219/121.7; 264/400; 428/134

(57) ABSTRACT

A composite sheet whose product price can be reduced with a smaller number of manufacturing processes. A laser oscillator outputs a pulsed beam at a frequency f. A mask shapes the outer shape of the beam into a triangular, quadrangular or hexagonal shape. N pieces of time-sharing means time-share the beam to form N beams having a frequency f/N. N pairs of positioning means position the time-shared beams. A condensing lens condenses the beams. A rotating drum displaces a workpiece. A control means controls the time-sharing means, the N pairs of positioning means and a pedestal. The N pairs of positioning means are positioned to irradiate predetermined positions with the beams. The pedestal is moved. The time-sharing means are thereupon operated in predetermined order. The workpiece is machined to make holes whose outer shapes depend on the mask so that distances between sides of adjacent holes are equal to one another.

### FIELD OF THE INVENTION

The present invention relates to a composite sheet such as an electromagnetic sheet serving for plasma TV and having a metal conductor layer and an organic compound layer put on top of each other in their thickness direction, a glass sheet (thin-plate glass) serving for liquid crystal TV and having a transparent glass layer coated with acrylic resin or epoxy resin mixed with powder of titanium or carbon, etc., a machining method for such a composite sheet, and a laser machining apparatus for machining such a composite sheet.

### BACKGROUND OF THE INVENTION

In a composite sheet serving for plasma TV, holes each having a quadrangular shape or the like are made in a metal conductor layer. In a composite sheet serving for liquid crystal TV, rectangular holes are made in a coating layer applied to the surface of a glass. In the background art, an exposure method or a transfer method has been used as a machining method for making such holes. In recent years, with the advance of a larger screen of plasma TV or liquid crystal TV, a screen size close to a size measuring 600 mm by 1,000 mm has been requested.

However, when the exposure method is used, a mask fitted to a screen size of plasma TV or the like has to be prepared as a mask for exposure. In addition, the exposure method requires a large number of manufacturing processes. Thus, it takes much time for manufacturing. Further, in respect of handling, it is impossible to increase the dimensions of a sheet or reduce the thickness of the sheet. It is therefore difficult to reduce the price of a product. Furthermore, it is difficult to make the open area ratio of holes (the open area ratio is expressed by dividing the area of a hole by the area of a figure including the dimensions of the hole margined with ½ of a distance to an adjacent hole) not lower than 90%, or to reduce the distance between adjacent ones of the holes. Also in the transfer method, in the same manner as in the exposure method, it is difficult to reduce the price of a product, or it is difficult to make the open area ratio of holes not lower than 90% or to reduce the distance between adjacent ones of the holes.

### SUMMARY OF THE INVENTION

An object of the present invention is to provide a composite sheet which can be manufactured in a smaller number of manufacturing processes, whose price as a product can be reduced and in which the open area ratio of holes can be made not lower than 90% and the distance between adjacent ones of the holes can be shortened, a machining method for the composite sheet, and a laser machining apparatus which is suitable for machining the composite sheet.

In order to solve the foregoing problems, a first configuration of the present invention provides a composite sheet including a first layer and a second layer serving as base layers and put on top of each other in a thickness direction thereof. The first configuration is characterized in that holes having one and the same triangular, quadrangular or hexagonal outer shape and having one and the same size are disposed in the second layer so that distances between sides of adjacent ones of the holes are equal to one another.

A second configuration of the present invention provides a machining method for a composite sheet including a first layer and a second layer serving as base layers and put on top of each other in a thickness direction thereof. The second configuration is characterized by machining the second layer with a laser beam so that holes having one and the same triangular, quadrangular or hexagonal outer shape and having one and the same size are disposed in the second layer so that distances between sides of adjacent ones of the holes are equal to one another.

A third configuration of the present invention provides a laser machining apparatus including a laser oscillator which outputs a pulsed laser beam at a frequency f, a mask which shapes an outer shape of the laser beam into one of a triangle, a quadrangle and a hexagon, N pieces of time-sharing means which time-share the laser beam so as to form N laser beams each having a frequency of f/N, N pairs of positioning means which position the time-shared laser beams, a condensing lens which condenses the laser beams, a displacement means for displacing a laser irradiation portion in which the positioning means for the laser beams and the condensing lens are disposed, or a workpiece, and a control means for controlling the time-sharing means, the positioning means and the displacement means. The third configuration is characterized in that the control means makes control to position the N pairs of positioning means so as to irradiate predetermined positions with the laser beams, and to thereafter operate the displacement means, to thereupon operate the time-sharing means in predetermined order, and to machine the workpiece to make holes whose outer shapes depend on the mask, so that distances between sides of adjacent ones of the holes are equal to one another.

In the first and second configurations, an electromagnetic sheet having a metal conductor layer and an organic compound layer put on top of each other in their thickness direction, or a glass sheet having a transparent glass layer coated with acrylic or epoxy resin mixed with powder of titanium or carbon is used as the composite sheet.

The manufacturing processes can be reduced on a large scale, and the thickness of the composite sheet can be reduced. Accordingly, when the composite sheet is a composite sheet for plasma TV, the composite sheet can be produced as a windable long sheet. Further, the yield of materials can be improved. It is therefore possible to reduce the price of a product. In addition, when the composite sheet is a composite sheet for liquid crystal TV, the number of manufacturing processes can be reduced. It is therefore possible to reduce the price of a product.

### BRIEF DESCRIPTION OF THE DRAWINGS

FIG. 1 is a sectional view of a composite sheet according to an embodiment of the present invention;

FIGS. 2A-2C are diagrams showing examples of arrangements of windows which are hexagonal;

FIGS. 3A-3E are diagrams showing examples of arrangements of windows which are quadrangular;

FIG. 4 is a diagram showing a fundamental configuration of an optical system according to the embodiment;

FIG. 5 is a perspective view showing a configuration of a workpiece displacement unit according to the embodiment;

FIG. 6 is a diagram for explaining the operation where hexagonal windows are machined out according to the embodiment;

FIG. 7 is a diagram for explaining the operation where each square window is machined out by a plurality of pulses according to the embodiment;

FIG. 8 is a diagram showing an applied configuration of an optical system according to the present invention;

FIG. 9 is a diagram showing a configuration of optical path deflectors of a machining head suitable for the optical system shown in FIG. 8;

FIG. 10 is a diagram showing another configuration of optical path deflectors in a machining head suitable for the optical system shown in FIG. 8;

FIG. 11 is a diagram for explaining the operation where equilateral hexagonal windows are machined out when the optical system in FIG. 8 is used;

FIG. 12 is a diagram showing an arrangement of beams when square windows in FIG. 7 are machined out;

FIG. 13 is a diagram showing an example where the configuration described in FIG. 8 is expanded and another laser oscillator and another conversion optics in FIG. 9 are provided additionally;

FIG. 14 is a diagram showing an example where the reflecting mirror in FIG. 13 is replaced by a prismatic reflecting mirror provided with two reflecting surfaces;

FIG. 15 is a diagram showing an example of an arrangement of beams when equilateral hexagonal windows are machined out by a laser machining apparatus shown in FIG. 13 and FIG. 14;

FIG. 16 is a diagram showing a configuration of another optical system where two other laser oscillators and two other pieces of conversion optics shown in FIG. 9 are added;

FIG. 17 is a diagram showing an example of an arrangement of equilateral hexagonal windows machined out by the optical system in FIG. 16;

FIG. 18 is a diagram showing a configuration of a laser machining apparatus which can improve the machining efficiency when windows are square;

FIGS. 19A and 19B are enlarged views of a workpiece according to the embodiment; and

FIGS. 20A and 20B are diagrams showing a modification of FIG. 19.

### DETAILED DESCRIPTION OF THE EMBODIMENTS

Embodiments of the present invention will be described below with reference to the drawings.

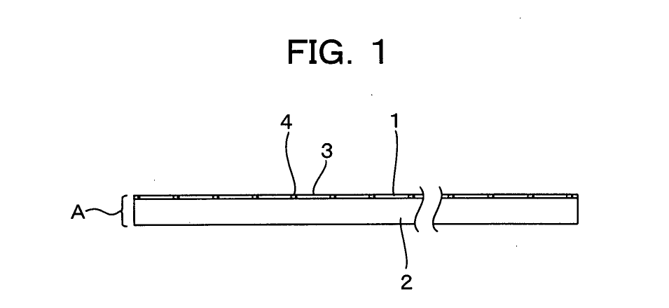

FIG. 1 is a sectional view of a composite sheet according to an embodiment of the present invention.

A composite sheet A is composed of a metal conductor layer 1 (hereinafter referred to as “conductor layer”) and a transparent organic compound layer 2 (PET in this embodiment). The composite sheet A is about 1,000 mm wide (in a direction perpendicular to the paper) and about 1,000 m long (in the left/right direction of FIG. 1). The material of the conductor layer 1 is copper. The conductor layer 1 is laminated substantially uniformly on one surface of the organic compound layer 2 by sputtering. The conductor layer 1 is 1 μm thick, and the organic compound layer is not thicker than 100 μm.

Holes 3 (hereinafter referred to as “windows”) are disposed in the conductor layer 1 in the arrangement which will be described later. Hereinafter, portions of the conductor layer 1 excluding the windows 3 will be referred to as “conductor lines 4”. The outer shapes of the windows 3 belong to one kind of a triangle, a quadrangle and a hexagon, and the windows 3 are disposed so that distances between adjacent ones of the windows 3 are equal to one another, as will be described in detail later.

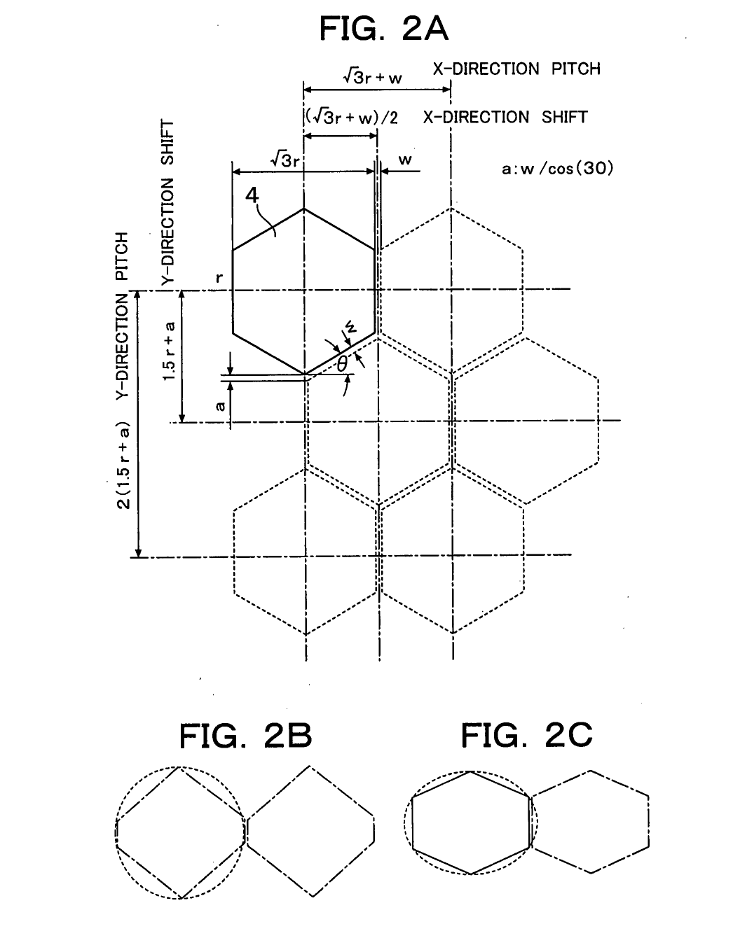

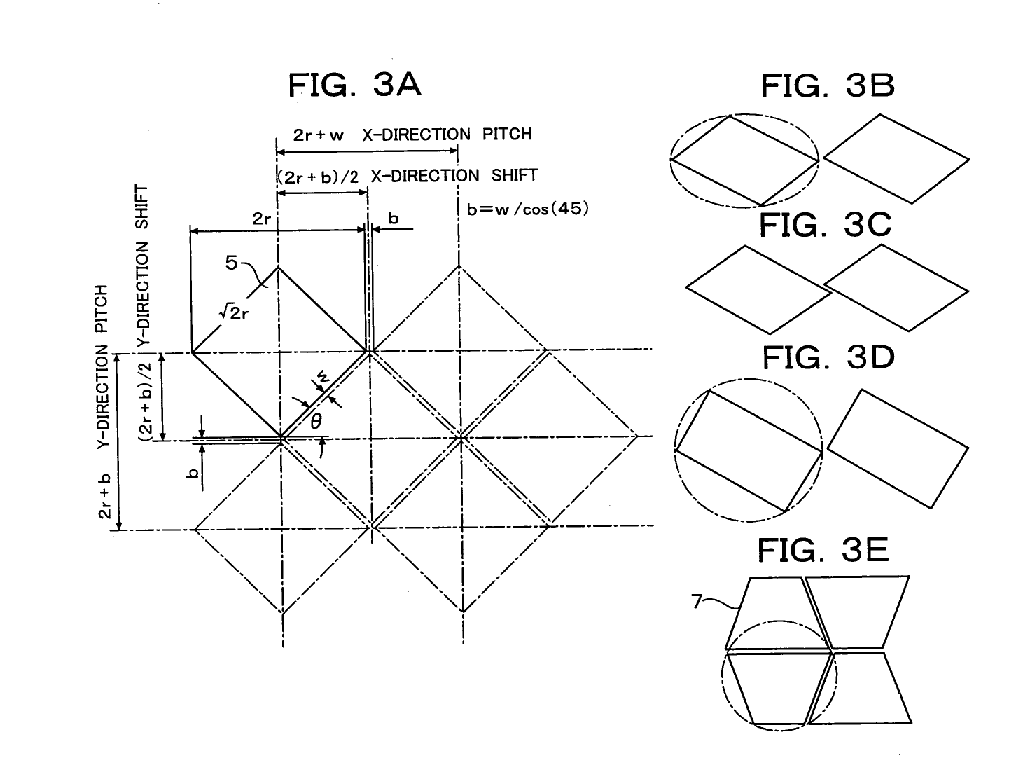

FIGS. 2A-2C and FIGS. 3A-3E are diagrams showing examples of arrangements of the windows 3. FIG. 2A shows an arrangement where the outer shape of each window 3 is an equilateral hexagon, FIG. 2B shows an arrangement where the outer shape of each window 3 is a hexagon inscribed in a circle and having different sides, and FIG. 2C shows an arrangement where the outer shape of each window 3 is a hexagon inscribed in an ellipse. FIG. 3A shows an arrangement where the outer shape of each window 3 is a square, FIG. 3B shows an arrangement where the outer shape of each window 3 is a parallelogram inscribed in an ellipse, FIG. 3C shows a modification of the arrangement shown in FIG. 3B, FIG. 3D shows an arrangement where the outer shape of each window 3 is a rectangle, and FIG. 3E shows an arrangement where the outer shape of each window 3 is a trapezoid inscribed in a circle.

As is apparent from FIGS. 2A-2C and FIGS. 3A-3E, in each arrangement, the windows 3 can be disposed so that distances between sides of adjacent ones of the windows are fixed. A laser beam is usually adjusted so that any section perpendicular to the optical axis of the laser beam will be formed into a circle. It is therefore possible to use the energy of the laser beam effectively when the outer shape of each window 3 is set as a triangle, a quadrangle or a hexagon inscribed in the circle.

That is, when R designates the radius of the laser beam incident on the mask which will be described later, the effective utilization of the beam can be expressed by the ratio of the open area of the mask to the area (πR²) of the beam. The area of a mask whose outer shape is an equilateral hexagon inscribed in the beam with the radius R is about 1.5√3R². The area of a square mask is 2R². Therefore, the effective utilization of the beam in the equilateral hexagonal mask is about 83%, while the effective utilization of the beam in the square mask is about 64%. Thus, the effective utilization of the beam in the equilateral hexagonal mask is about 30% higher than the effective utilization of the beam in the square beam, so that the machining speed can be improved by about 30%.

Assume that the left/right X-direction in FIGS. 2A-2C and FIGS. 3A-3E is the left/right X-direction of plasma TV. In this case, when the windows 3 are disposed so that one of the sides of each window 3 crosses the X-direction, it is possible to prevent moire fringes from occurring.

Here, the pitch with which the windows 3 are disposed is kept not longer than 300 μm, the conductor line width is kept not wider than 15 μm, and the open area ratio (open area ratio=[area of an window 3/(area of the window 3+area of a figure including dimensions of the window 3 margined with ½ of a distance to an adjacent window 3) is kept not lower than 90%. Thus, the permeability of light passing through the windows 3 is enhanced so that the quality of an image can be kept, and harmful light is blocked by the conductor lines 4 so that an electromagnetic shield effect can be provided.

Particularly in FIG. 2A, the outer shape of each window 3 is an equilateral hexagon (including a hexagon where a pair of opposite sides is longer or shorter than any other pair of opposite sides). Thus, two pairs of opposite sides are inclined at angles of ±30 degrees with respect to the X-axis while phosphors are disposed like a grid along the coordinate axes. It is therefore possible to reduce occurrence of moire fringes. In the same manner, in FIG. 3A, due to the windows 3 which are square, opposite sides are inclined at angles of ±45 degrees. It is therefore possible to reduce occurrence of moire fringes.

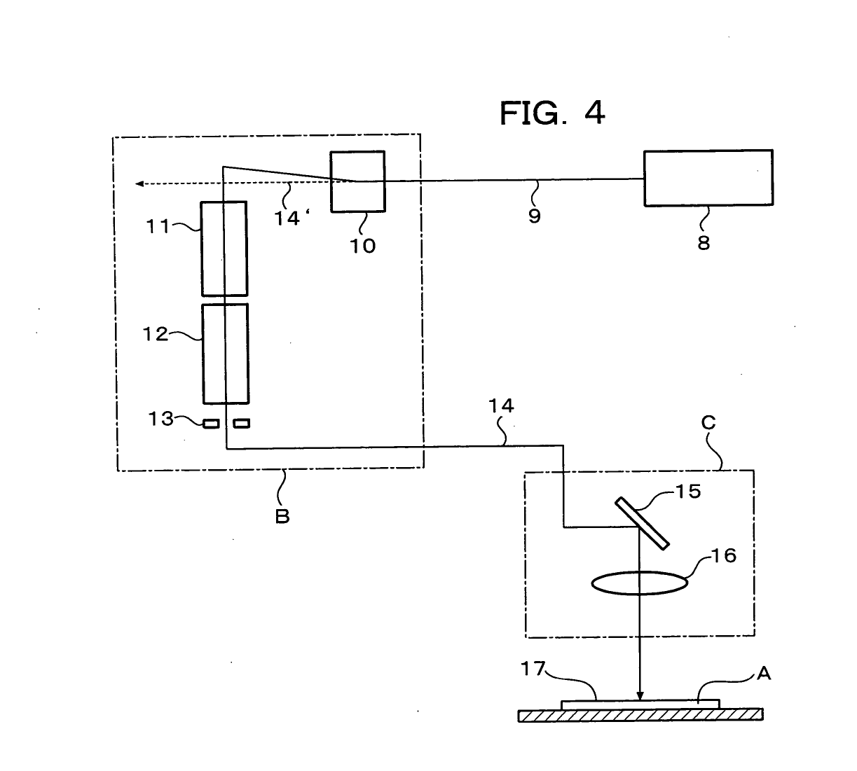

FIG. 4 is a diagram showing a fundamental configuration of an optical system in this embodiment.

In FIG. 4, a laser oscillator 8 has a lasing medium of YVO4, YAG or YLF, and outputs a pulsed laser beam 9 with a wavelength of 1,000-1,200 nm. The wavelength of the laser beam 9 is not limited to the aforementioned wavelength, but the laser beam 9 may be a second harmonic, a third harmonic, a fourth harmonic or a fifth harmonic obtained by wavelength conversion of a fundamental wave using a wavelength conversion crystal such as BBO (β·BaB₂O₄), LBO (LiB₃O₅) or CLBO (CsLiB₆O₁₀).

The energy (power) of the laser beam 9 is adjusted by an acoustooptical beam distributor 10 so as to form a beam 14′. The energy distribution of the beam 14′ is made flat (into a so-called top-hat beam) by a beam mode shaper 11. The outer diameter of the beam 14′ is adjusted by a collimator 12 for beam diameter adjustment. Further, the outer shape of the beam 14′ is shaped (for example, into an equilateral hexagon) by a mask 13 so as to form a beam 14. Hereinafter, the beam distributor 10, the beam mode shaper 11, the collimator 12 and the mask 13 will be collectively referred to as “conversion optics B”. The beam 14 is introduced onto a fixed reflecting mirror 15 of a machining head C. The shape of the mask 13 is scaled down and projected onto a surface 17 of the composite sheet A by a condensing lens 16. Thus, windows 3 are formed in the metal conductor layer 1 of the composite sheet A.

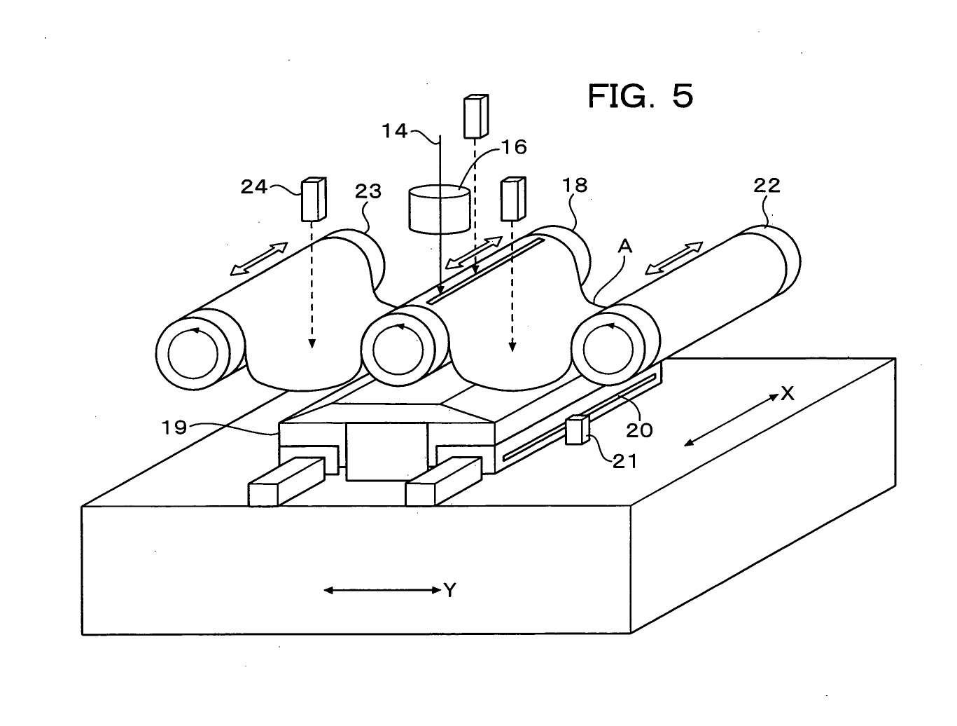

FIG. 5 is a perspective view showing a configuration of a workpiece displacement unit.

A rotatable rotating drum 18 has a sheet suction mechanism (not shown) of a vacuum system on its surface so as to displace the composite sheet A. A rotatable let-off unit 22 holds the composite sheet A which has been wound like a coil and which has not been machined. A rotatable take-up unit 23 holds the composite sheet A which has been machined. The surface of the rotating drum 18 and the uppermost layer of the composite sheet A wound around the let-off unit 22 and the take-up unit 23 are positioned in the rotation direction with a positioning accuracy of 2 μm.

The rotating drum 18, the let-off unit 22 and the take-up unit 23 are retained on a pedestal 19 movably in the illustrated X-direction. The position of the pedestal 19 is controlled by a scale 20 and a sensor 21. The pedestal 19 is positioned with a positioning accuracy not longer than 2 μm. Three cameras 24 monitor the shape of each window, the condition of the window and the condition of the sheet.

Next, a machining procedure will be described.

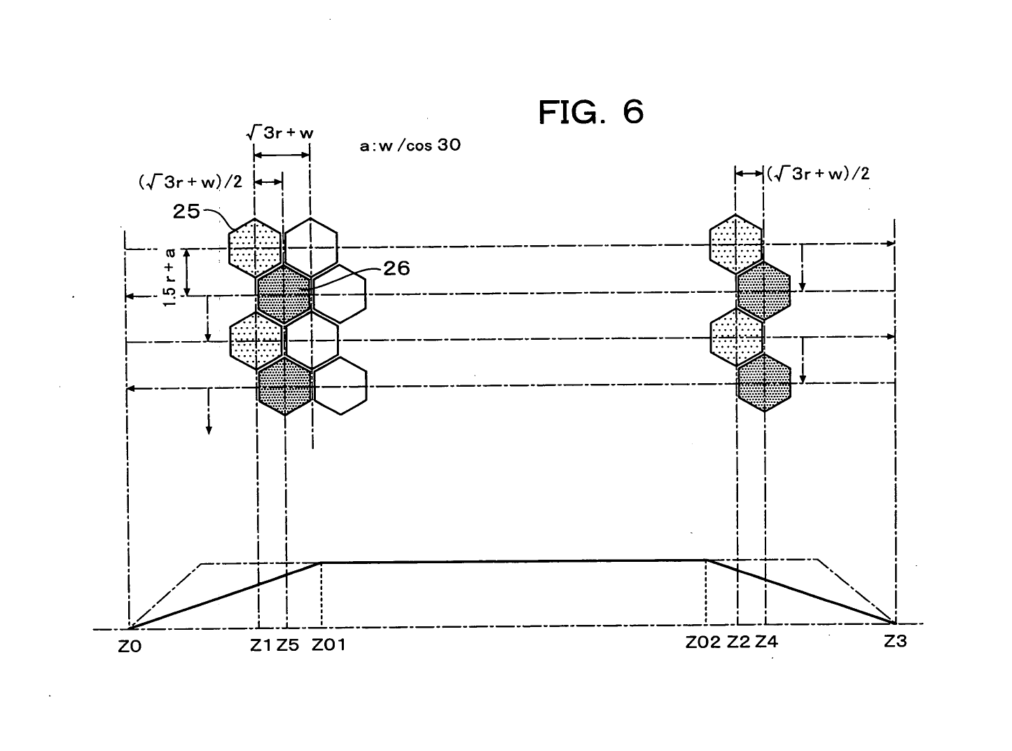

FIG. 6 is a diagram for describing the operation where hexagonal windows are machined out. The upper half of FIG. 6 depicts the arrangement of the windows, and the lower half of FIG. 6 depicts a velocity diagram of the pedestal 19.

(1) First, the rotating drum 18 to which the composite sheet A has been fixed by the suction mechanism is fixed to a predetermined position. In addition, the pedestal 19 is positioned at a start position Z0.

(2) A machining start command is issued. In response thereto, the pedestal 19 begins to move while the laser oscillator 8 is turned on.

(3) As soon as the pedestal 19 arrives at a position Z1, a laser beam is radiated. Till then the laser beam has reached a pulse frequency domain where the pulse energy is stable. That is, the start position Z0 is defined on the basis of the position Z1 in concert to the time for the laser beam to reach the pulse frequency domain where the pulse energy is stable. The pedestal 19 moves at a constant velocity when the pedestal 19 has reached the position Z01.

(4) After that, the laser beam is radiated whenever the pedestal 19 moves a distance (√3r+w). Here, r designates the radius of a circle where each window is inscribed, and w designates a distance between windows (between sides of adjacent windows). (See FIGS. 2A-2C)

(5) The pedestal 19 is braked at a position Z02.

(6) Machining the first line is terminated at a position Z2. By the aforementioned operation, windows (the reference numeral 25 in FIG. 6) in the first line in FIG. 6 are machined out.

(7) The rotating drum 18, the let-off unit 22 and the take-up unit 23 are operated (rotated) so that the composite sheet A is displaced in the Y-direction (the up/down direction in FIG. 6) by a distance (1.5r+a). Here, the relation a=w/cos 30° is established. (See FIGS. 2A-2C)

(8) The pedestal 19 is positioned at a start position Z3.

(9) A machining start command is issued. In response thereto, the pedestal 19 begins to move while the laser oscillator 8 is turned on.

(10) As soon as the pedestal 19 arrives at a position Z4, a laser beam is radiated. Till then the laser beam has reached a pulse frequency domain where the pulse energy is stable. That is, the start position Z3 is defined on the basis of the position Z4 in concert to the time for the laser beam to reach the pulse frequency domain where the pulse energy is stable. The pedestal 19 moves at a constant velocity when the pedestal 19 has reached the position Z02.

(11) After that, the laser beam is radiated whenever the pedestal 19 moves a distance (√3r+w). (See FIGS. 2A-2C)

(12) The pedestal 19 is braked at the position Z01.

(13) Machining the second line is terminated at a position Z5. By the aforementioned operation, windows (the reference numeral 26 in FIG. 6) in the second line in FIG. 6 are machined out.

(14)

After that, the operations (1) to (13) are repeated till the pedestal 19 arrives at a machining end point in the longitudinal direction of the composite sheet A.

The window shift amount between the first line and the second line is (√3r+w)/2.

As shown in FIGS. 3A-3E, an window matrix which is √2r square can be machined out in a procedure similar to the aforementioned procedure. In this case, when w designates a distance between windows and the relation b=w/cos 45° is established, the X-direction pitch is (2r+w) and the Y-direction pitch is (r+b).

Here, specific description will be made about the relationship between the thickness of a conductor layer and the size of each window when the window is formed by one pulse.

A conductor layer was perforated by a UV laser with a wavelength of 355 nm, a pulse frequency of 30 KHz and a machining portion average output of 2.75 W, using a hexagonal mask whose circumcircle has the same diameter as that of a laser beam. When the conductor layer was 0.5 μm thick, hexagonal windows each having an opposite side distance of about 155 μm and a width across corner of about 175 μm were obtained.

When the conductor layer was 0.3 μm thick or 0.1 μm thick, hexagonal windows each having an opposite side distance of about 160 μm and a width across corner of about 180 μm were obtained.

In the same manner, a square mask whose circumcircle has the same diameter was used. When the conductor layer was 0.5 μm thick, square windows each having an opposite side distance of about 147 μm were obtained.

When the conductor layer was 0.3 μm thick or 0.1 μm thick, square windows each having an opposite side distance of about 150 μm were obtained.

That is, the thicker the conductor layer is, the smaller the windows are. Accordingly, in order to form large windows in a thick conductor layer, it is necessary to perform machining on each window with a plurality of pulses using beams for machining small partial windows.

In the aforementioned test, proper energy density was 0.2-0.4 J/cm². That is, when the energy density was lower than 0.2 J/cm², there was a case where the metal conductor layer survived partially in the surface of the organic compound layer. When the energy density was higher than 0.4 J/cm², there was a case where the surface of the organic compound layer was damaged.

When the composite sheet was a liquid-crystal composite sheet (glass sheet) coated with acrylic resin mixed with titanium powder so as to be 1 μm thick, the energy density high enough to form each window measuring 100 μm by 150 μm was about 1 J/cm², and the number of pulses required for the window was 10. In the same manner, when the composite sheet was a liquid-crystal composite sheet (glass sheet) coated with epoxy resin mixed with titanium powder so as to be 1 μm thick, the energy density high enough to form each window measuring 100 μm by 150 μm was about 1 J/cm², and the number of pulses required for the window was 10.

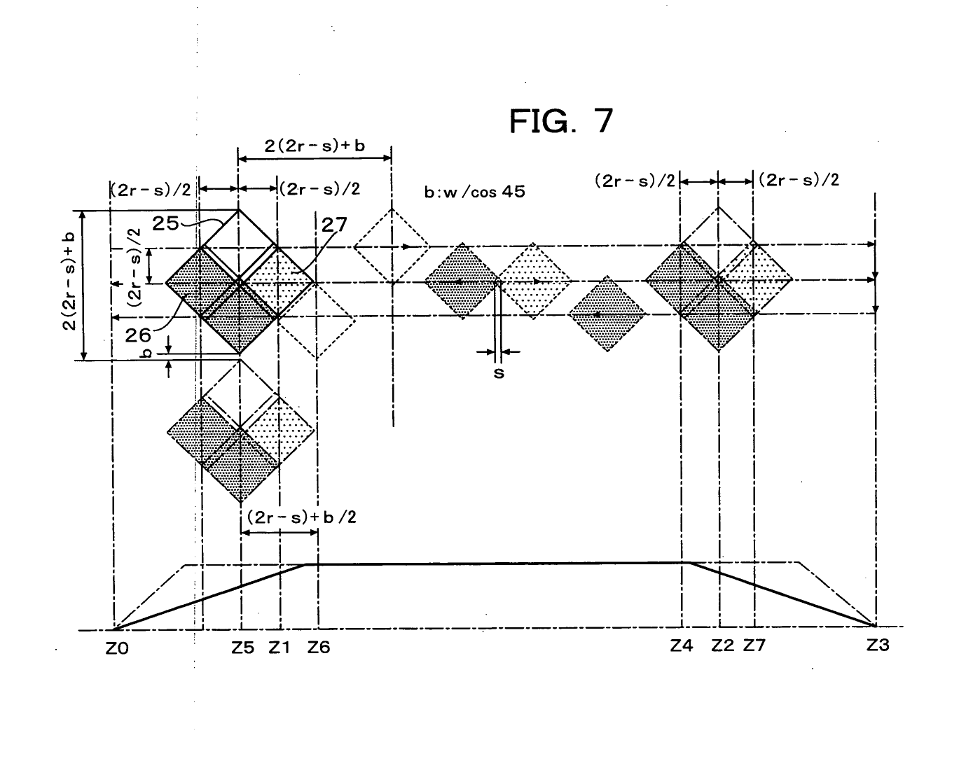

FIG. 7 is a diagram for explaining the operation where each square window is machined by a plurality of pulses. The upper half of FIG. 7 depicts the arrangement of windows, and the lower half of FIG. 7 depicts a velocity diagram of the pedestal 19.

Hereinafter, an window which can be machined out by one pulse will be referred to as “partial window”. Assume that a partial window and another partial window are laid to overlap each other by a distance s (=3 μm).

Also in this case, machining can be performed in the procedure described in FIG. 6, but machining must be performed doubly in each even line as compared with machining in each odd line. As shown in FIG. 7, after windows (the reference numeral 25 in FIG. 7) in the first line are machined out, one-side windows (the reference numeral 26 in FIG. 7) in the second line are machined out in the leftward travel in the second line. In the left end, the line to be machined is not changed, but machining is performed rightward at that position so as to form the other windows (the reference numeral 27 in FIG. 7) in the second line. Distances among partial windows etc. are shown in FIG. 7. That is, when w designates a distance between windows and the relation b=w/cos 45° is established, windows can be finally formed at a pitch 2(2r−s)+b both in the X-direction and in the Y-direction.

Next, description will be made about a case where the number of beams is increased.

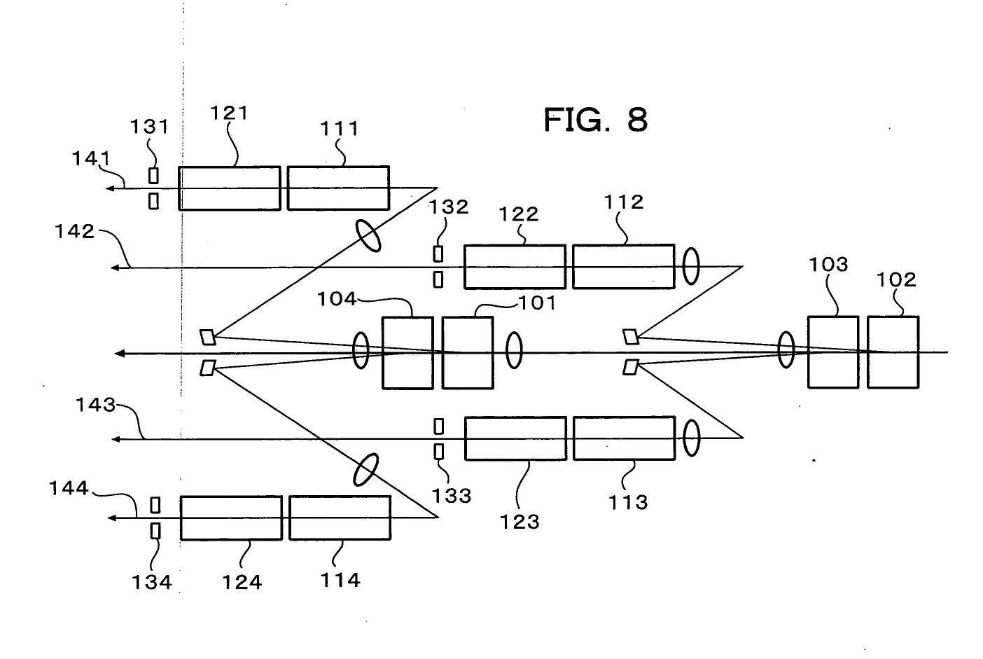

FIG. 8 is a diagram showing an applied configuration of an optical system according to the present invention. The beam distributor in FIG. 4 is replaced by four distributors while the conversion optics B is replaced by four pieces of conversion optics. Constituent parts in FIG. 8 are referenced by three-digit numerals where 1 to 4 are suffixed to the reference numerals in FIG. 4 respectively. Each beam 141, 142, 143, 144 is designed to be positioned, for example, by optical path deflectors (a pair of optical scanners) which will be described later, so that the beams 141, 142, 143 and 144 are incident on one condensing lens 16. In this optical system, beam distributors 101, 102, 103 and 104 are, for example, controlled so that the beams 141, 142, 143 and 144 can be made incident on the condensing lens 16 in that order.

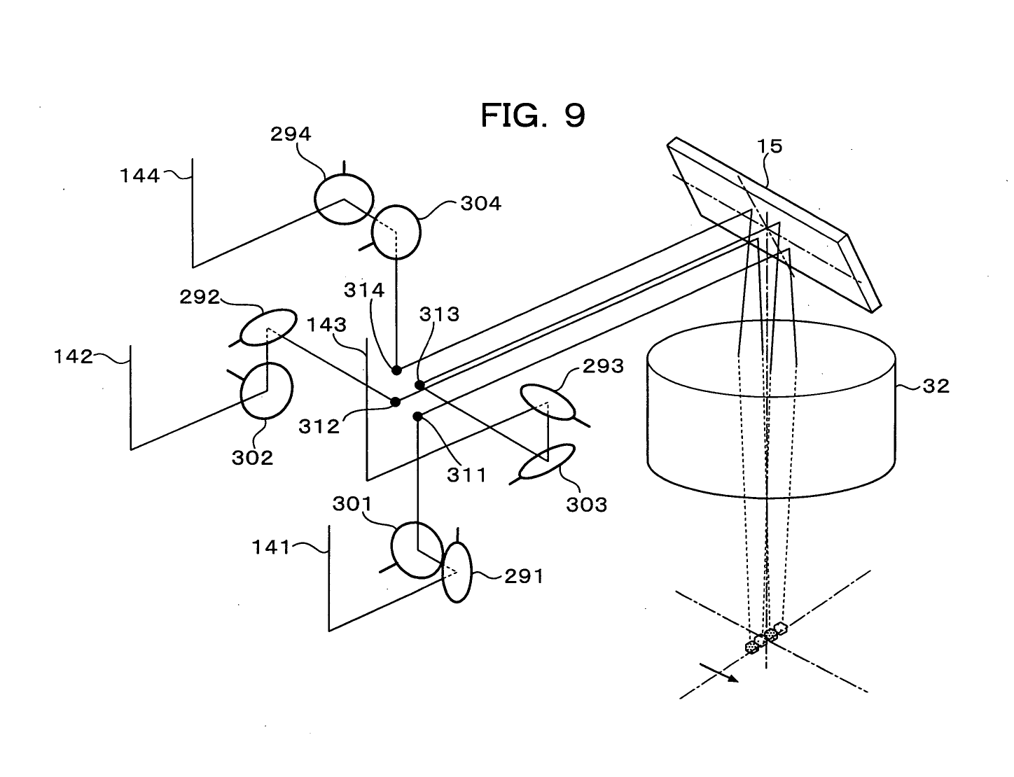

FIG. 9 is a diagram showing a configuration of optical path deflectors of a machining head suitable for the optical system shown in FIG. 8.

The beams 141 to 144 are introduced into the machining head individually. The beam 141 passing through an optical scanner 291 and an optical scanner 301 which position their own mirrors rotatably, and a reflecting mirror 311 and a reflecting mirror 15, is introduced into an fθ lens 32 whose pupil diameter D is 50 mm. The beam 141 is scaled down and projected onto the surface 17 of the composite sheet A individually. In the same manner, the beams 142-144 passing through optical scanners 292-294, optical scanners 302-304, reflecting mirrors 312-314 and the reflecting mirror 15, are introduced into the fθ lens 32 whose pupil diameter D is 50 mm, respectively. The beams 142-144 are scaled down and projected onto the surface 17 of the composite sheet A individually. The reflecting mirrors 311, 312, 313 and 314 are disposed symmetrically with respect to the center of the reflecting surface of the reflecting mirror 15.

When f designates the focal length of the fθ lens 32 and θ designates the incident angle of each beam 141-144 on the fθ lens 32, the beam 141-144 goes out to a position at a distance fθ from the central axis of the fθ lens 32 in the focal plane. Accordingly, when the incident angle θ is small and even when an offset length L of each of the four beams is large on the incident side, the beam can be condensed near the central axis of the fθ lens 32 if the beam including the beam diameter d falls into the pupil, that is, if D>2L+d. For example, assume that f=150 mm. In this case, if d<15 when L=15 mm, and if d<10 when L=20, each beam can be positioned in a desired position in an area measuring 5 mm by 5 mm centering the central axis of the fθ lens in the X- and Y-directions by controlling the optical scanner 291, 292, 293, 294 and the optical scanner 301, 302, 303, 304.

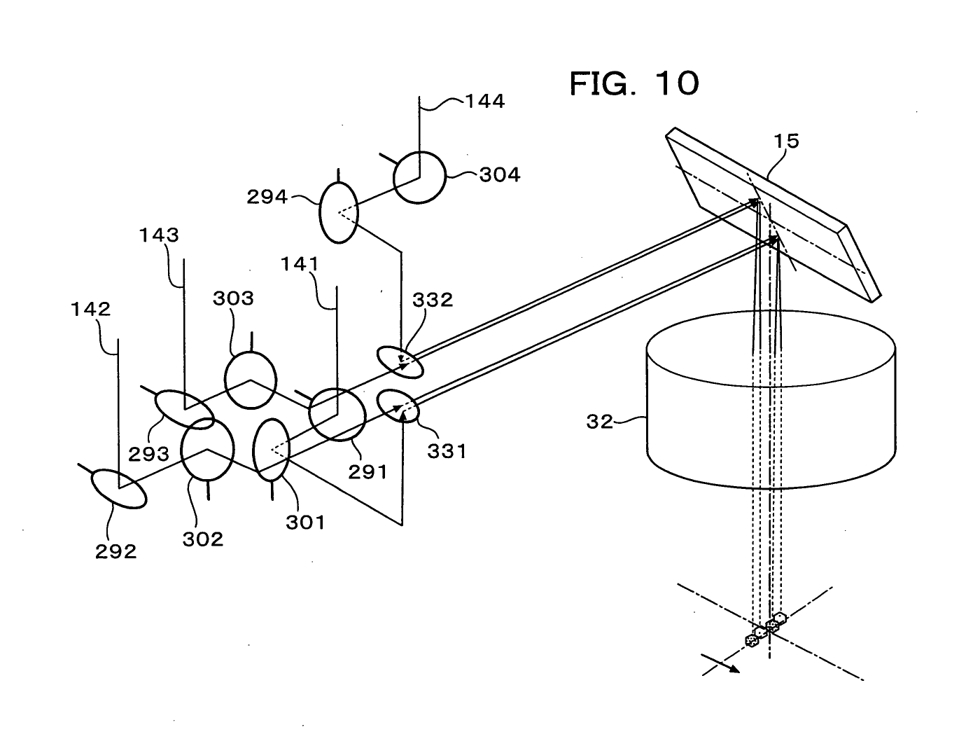

FIG. 10 is a diagram showing another configuration of optical path deflectors in a machining head suitable for the optical system shown in FIG. 8.

In this embodiment, the beams 142 and 143 are converted into P waves by not-shown polarizing means before they are incident on polarizing beam splitters 331 and 332. The beams 142 and 143 are then introduced into the machining head. The beams 142 and 143 passing through optical scanners 292, 302, 293 and 303 penetrate the polarizing beam splitters 331 and 332 disposed in positions where the reflecting mirrors 311 to 314 are disposed in FIG. 9. The beams 142 and 143 are then introduced into the fθ lens 32 via the reflecting mirror 15.

On the other hand, the beams 141 and 144 are converted into S waves halfway in their optical paths. The beams 141 and 144 are then introduced into the machining head. The beams 141 and 144 passing through optical scanners 291, 301, 294 and 304 are reflected by the beam splitters 331 and 332. The beams 141 and 144 are then introduced into the fθ lens 32 via the reflecting mirror 15.

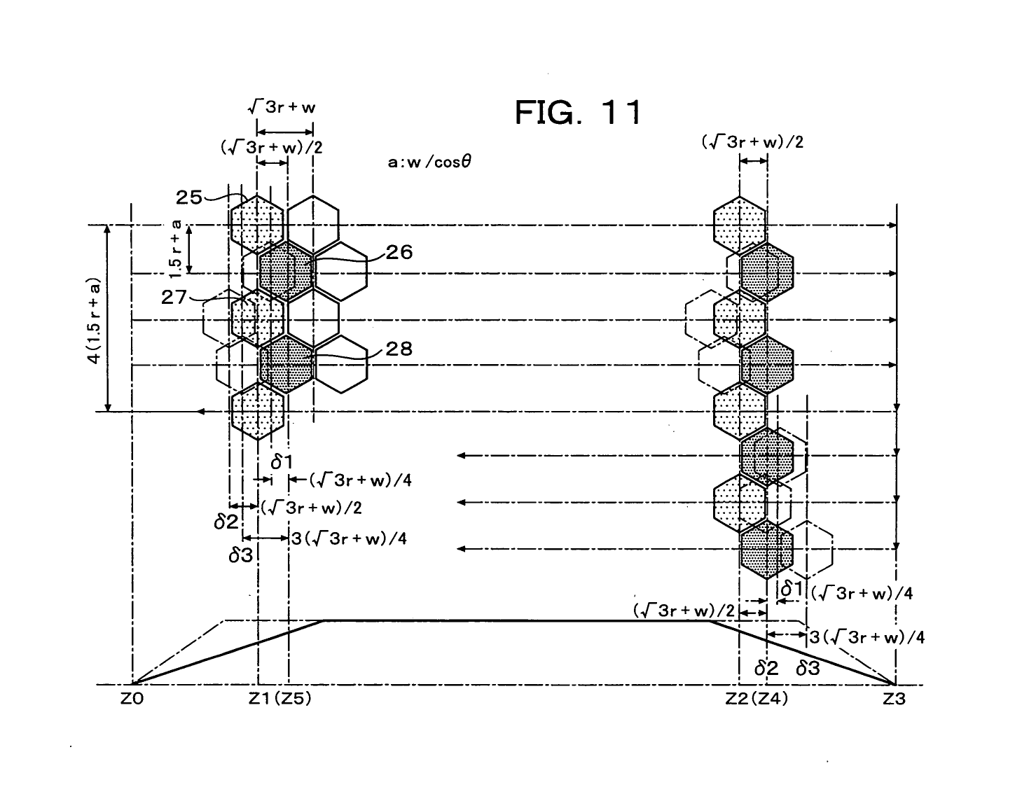

FIG. 11 is a diagram showing an example of an arrangement of windows when the optical system in FIG. 8 is used. FIG. 11 shows the case where equilateral hexagonal windows are machined out.

In this optical system, the laser beams 141 to 144 can be positioned in different positions respectively. For example, the optical axes of the laser beams 141-144 are positioned in the Y-direction so that the windows 25, 26, 27 and 28 can be machined out with the beams 141, 142, 143 and 144 respectively. There is a lag in irradiation time. For example, the optical axes of laser beams corresponding to the second to fourth lines are positioned to be shifted by a distance (√3r+w)/4 in the X-direction with respect to those in the first line. Irradiation is carried out by one of the beams 141 to 144 by a not-shown controller whenever the pedestal 19 moves the distance (√3r+w)/4. Thus, an window having a width of 4 (1.5r+a) in the Y-direction can be machined out whenever the pedestal 19 is moved once. The pulse oscillating frequency of the laser oscillator 8 and the operating frequencies of the beam distributors 101 to 104 are much higher than the moving velocity (machining pulse frequency×laser irradiation pitch) of the pedestal 19. It is therefore possible to shorten the machining time. Redundant description of specific operations will be omitted because the specific operations can be understood easily from the aforementioned case in FIG. 6.

When the laser beams are radiated sequentially in the column direction (X-direction), the period with which adjacent windows are machined out can be extended to 4/F seconds (F designate the laser oscillating frequency), and the adjacent windows can be prevented from being machined successively. It is therefore possible to relieve the conductor layer from deterioration due to heat affection or scattered debris.

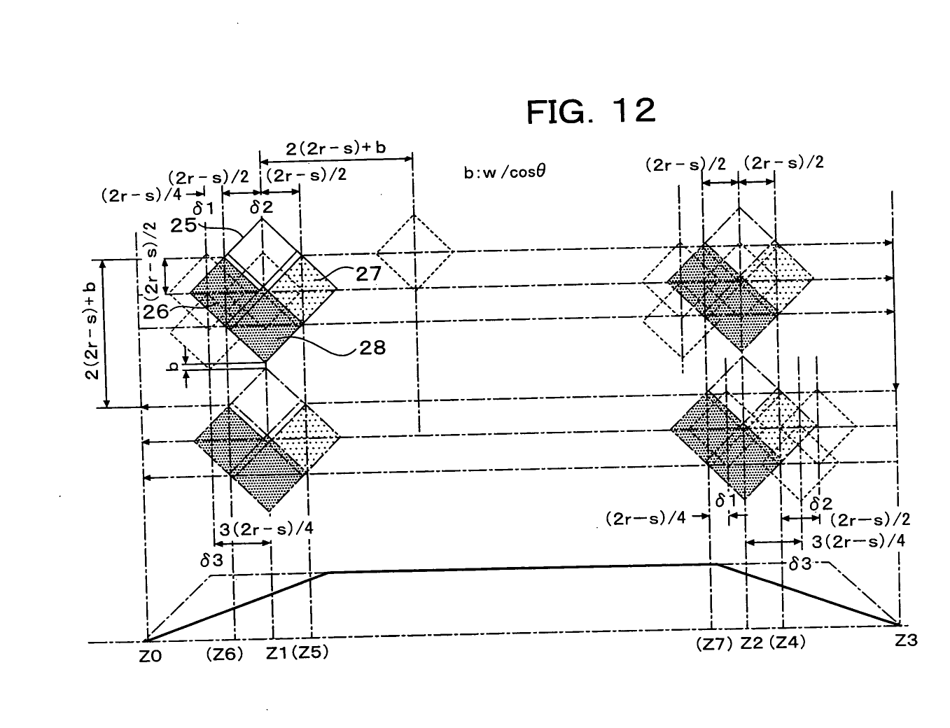

FIG. 12 is a diagram showing an arrangement of the beams 141-144 when square windows described in FIG. 7 are machined out with the beams 141-144.

In the case of FIG. 12, the optical axes of the laser beams 141-144 are positioned in the Y-direction so that the partial windows 25, 26, 27 and 28 can be machined out with the beams 141, 142, 143 and 144 respectively. There is a lag in irradiation time. For example, the optical axes of laser beams corresponding to the second to fourth lines are positioned to be shifted by a distance (2r−s)/4 in the X-direction with respect to those in the first line. Irradiation is carried out by one of the beams 141 to 144 by a not-shown controller whenever the pedestal 19 moves the distance (2r−s)/4. Thus, an window can be machined out in substantially half an area within a region of 2(2r−s)+b in the Y-direction width whenever the pedestal 19 is moved once. The pulse oscillating frequency of the laser oscillator 8 and the operating frequencies of the beam distributors 101 to 104 are much higher than the moving velocity of the pedestal 19. It is therefore possible to shorten the machining time. Redundant description of specific operations will be omitted because the specific operations can be understood easily from the aforementioned case in FIG. 6.

As is apparent from the aforementioned description, the machining speed can be improved as the number of beams which can be positioned in different positions is increased.

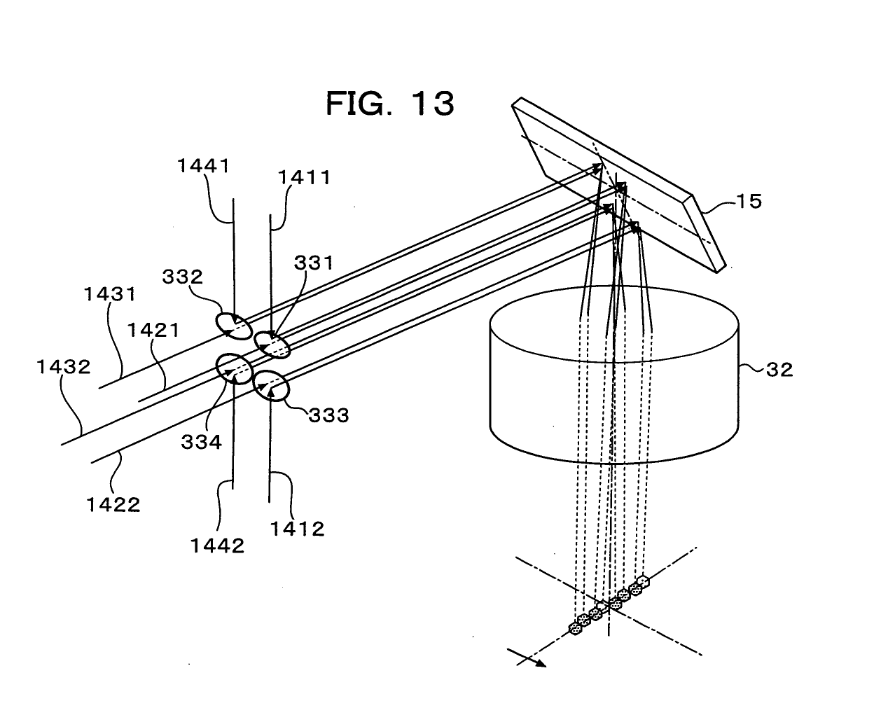

FIG. 13 shows an expansion of the configuration described in FIG. 8. In FIG. 13, another laser oscillator and another conversion optics in FIG. 9 are provided additionally so that 8 beams can be made incident on the reflecting surface of the reflecting mirror 15 of the machining head.

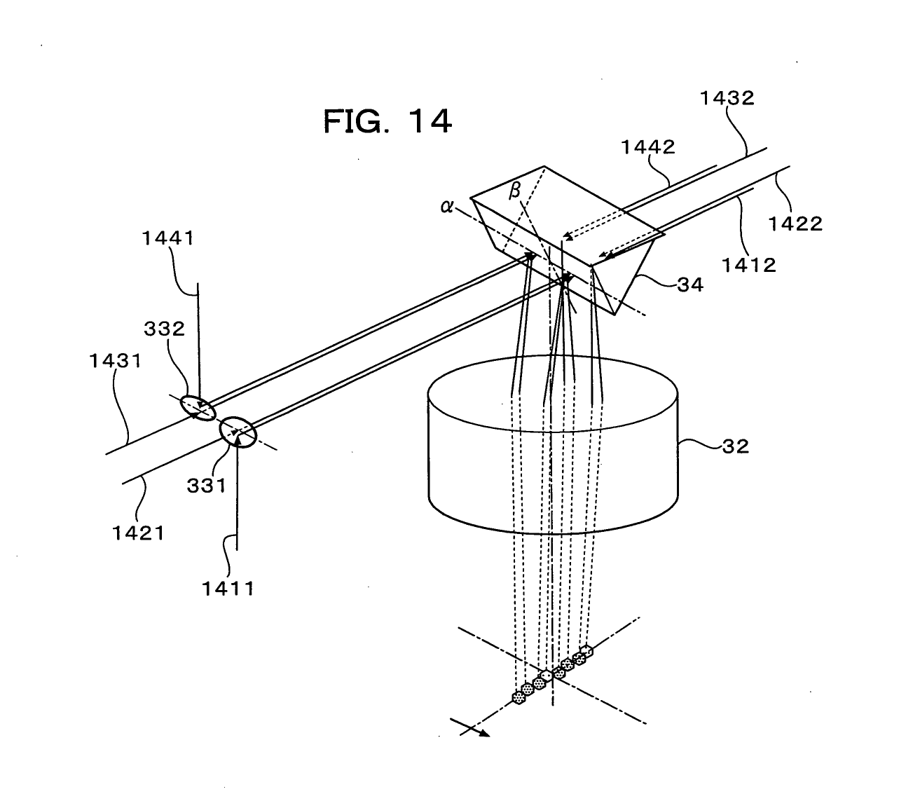

FIG. 14 shows an example where the reflecting mirror 15 in FIG. 13 is replaced by a prismatic reflecting mirror 34 provided with two reflecting surfaces.

Redundant description of specific operations will be omitted because the specific operations can be understood easily from the aforementioned case in FIG. 6.

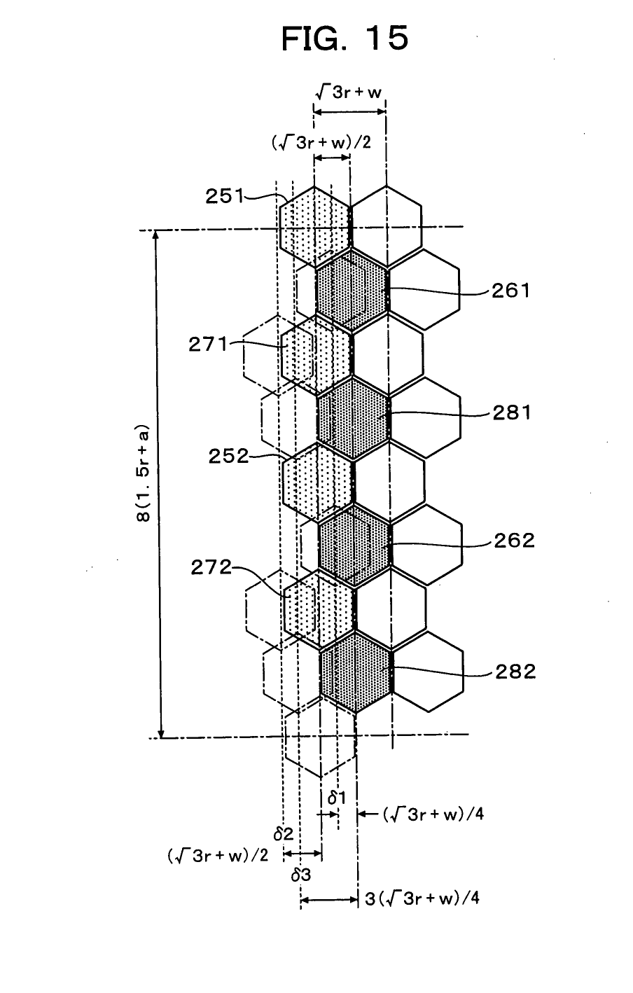

FIG. 15 shows an example of an arrangement of beams when equilateral hexagonal windows are machined out by the laser machining apparatus shown in FIG. 13 and FIG. 14.

As shown in FIG. 15, when the number of beams is 8, an area twice as wide as that when the number of beams is 4 can be machined at a time by one-time movement of the pedestal 19. It is therefore possible to improve the machining efficiency better.

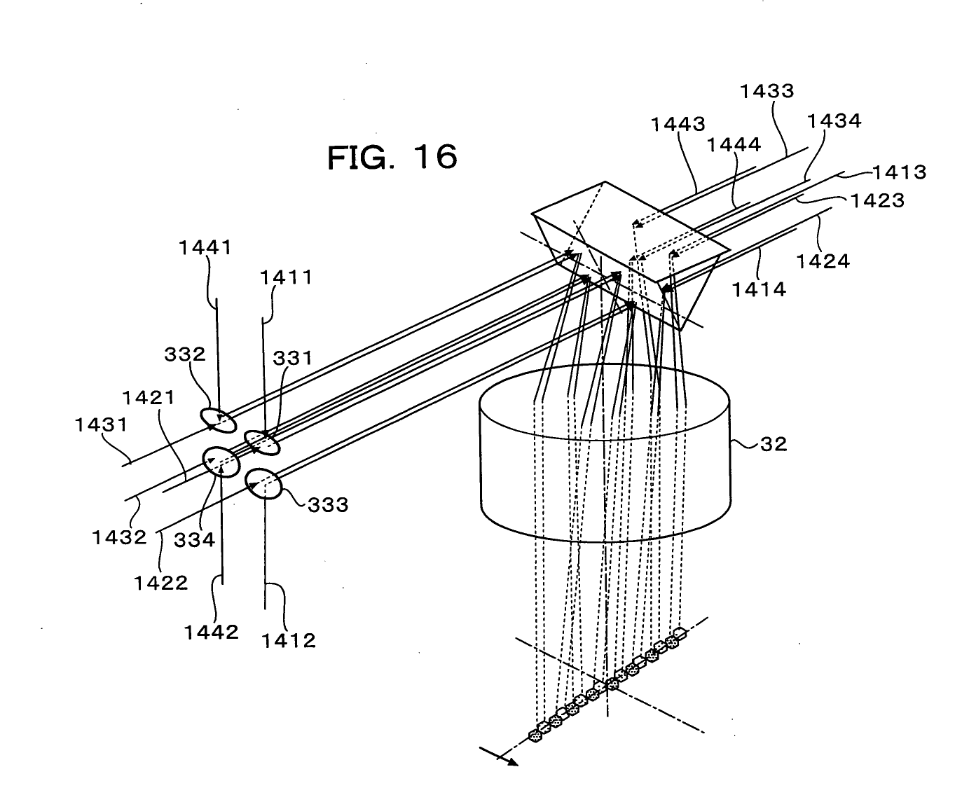

FIG. 16 is a configuration diagram of another optical system according to the present invention.

This configuration can be implemented by adding two other laser oscillators and two other pieces of conversion optics shown in FIG. 9.

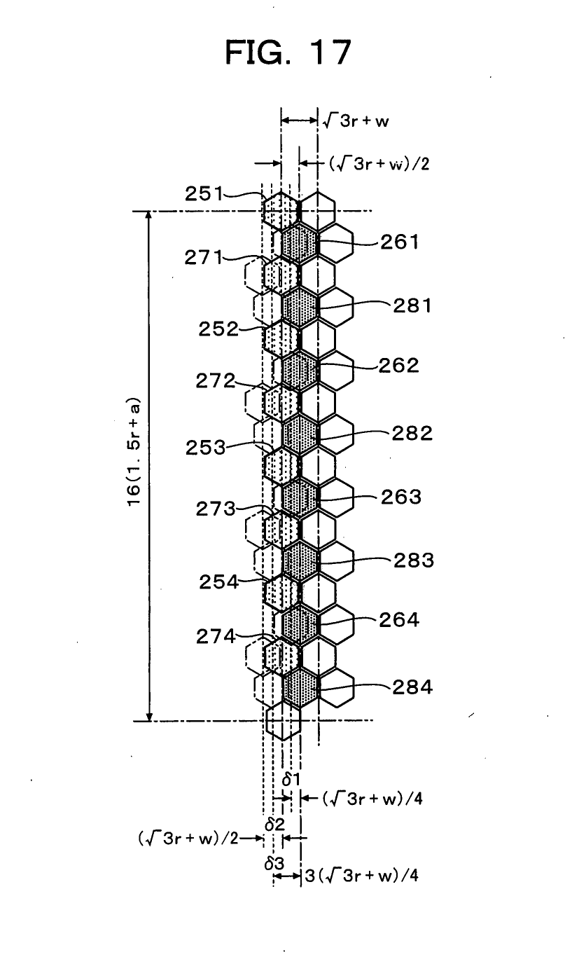

FIG. 17 shows an example of an arrangement of equilateral hexagonal windows machined out by the optical system in FIG. 16.

Redundant description of specific operations will be omitted because the specific operations can be understood easily from the aforementioned case in FIG. 6.

Though not shown, the machining head may be replaced by an X-direction scanning optics constituted by a polygon mirror with a number P of surfaces and a semi-cylindrical fθ lens. The X-direction scan by the polygon mirror and the Y-direction drum rotation are synchronized to condense beams into a machining portion of the fθ lens. In this case, accuracy in window dimensions, window shape and conductor line width deteriorates. Thus, the frequency of occurrence of a change in open area ratio or moire fringes increases slightly.

When regions to be irradiated with N laser beams are disposed in a straight line and a workpiece is moved relatively to the regions, the following conditions can be generally set. That is:

(1) If irradiation with the laser beams is carried out whenever the workpiece moves a fixed distance, the ratio between an acceleration period and a deceleration period in one traveling cycle becomes smaller relatively as the distance where the workpiece travels at a constant velocity is longer. It is therefore possible to improve the machining efficiency in a fixed time.

(2) When the capacity of the laser oscillator is secured to be enough large and the moving velocity of the workpiece is fixed, the machining efficiency can be improve as the interval of laser irradiation is shortened.

The same thing can be applied to the case where the workpiece is fixed and the regions to be irradiated with the laser beams are moved relatively to the workpiece.

Accordingly, when the windows are equilateral hexagonal, it will go well if the windows are disposed so that a pair of opposite sides of each window are put at right angles with the traveling direction of the composite sheet as shown in FIG. 11 (each window is shifted from a second adjacent window by ½ of the distance between two opposing sides when the windows are equilateral hexagonal, but the windows can be regarded as disposed substantially in a straight line).

On the other hand, when windows are square, the aforementioned conditions (1) and (2) can be satisfied in the following manner. Thus, the machining efficiency can be improved.

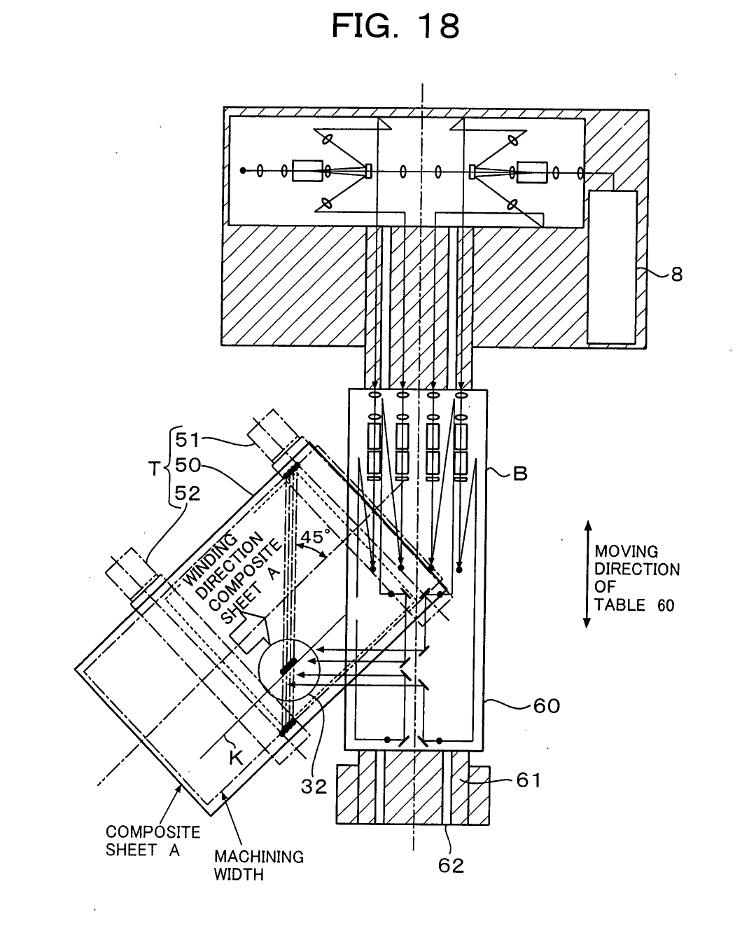

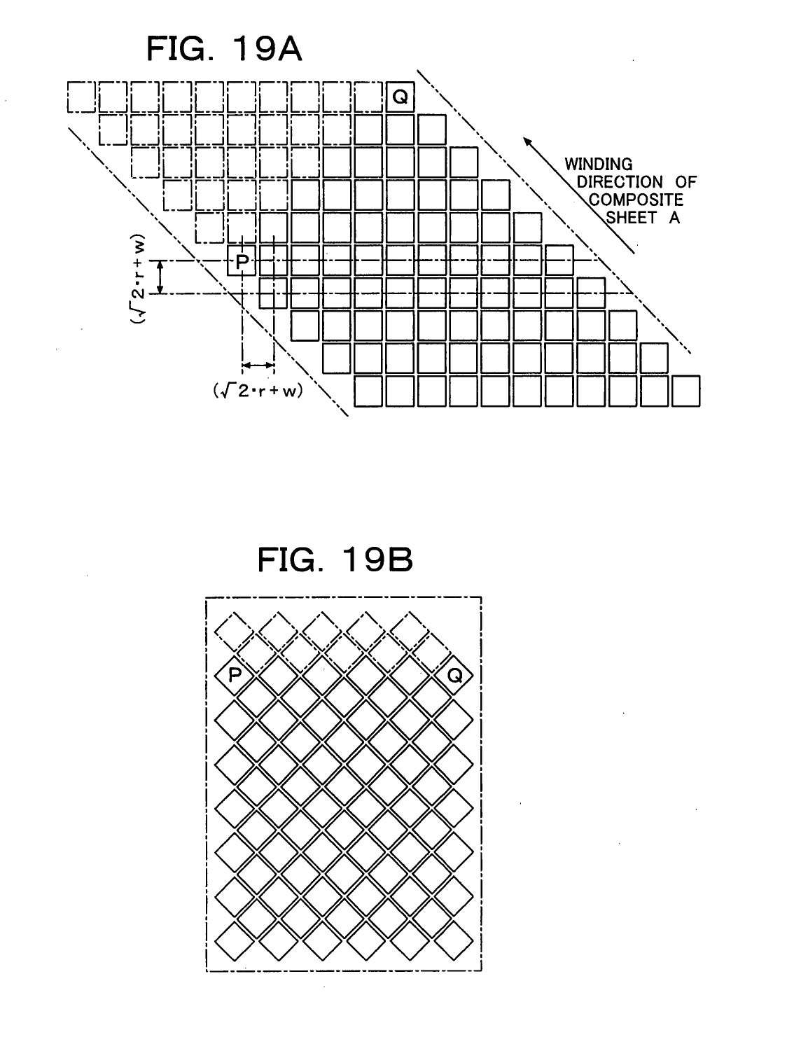

FIG. 18 is a configuration diagram of a laser machining apparatus which can improve the machining efficiency when windows are square. Parts the same as those in FIG. 4 are referenced correspondingly, and redundant description thereof will be omitted. FIGS. 19A and 19B are enlarged views of a workpiece. FIG. 19A shows a general view, and FIG. 19B shows an arrangement of windows as a product.

In FIG. 18, a laser irradiation portion including an fθ lens 32 is mounted on a table 60 which can move in the illustrated up/down direction on a linear guide 62 disposed on a base 61. Thus, the laser irradiation portion can move in the illustrated up/down direction. On the other hand, a composite sheet A is wound and positioned by a main positioning driving roll 51 and an accessory positioning driving roller 52. The main positioning driving roll 51 is disposed at one end of a flat sheet backup 50 having a sheet suction mechanism (not shown) of a vacuum system on its surface. The accessory positioning driving roller 52 is disposed to the other end of the sheet backup 50 (hereinafter the main positioning driving roll 51, the sheet backup 50 and the accessory positioning driving roller 52 will be collectively referred to as “table T”).

Laser beams (four beams in the illustrated case) are positioned to be arrayed in a straight line K which is at an angle of 45 degrees with the moving direction of the table 60. The table T is positioned in a direction where the composite sheet A can be wound in the direction of the straight line K. The table 60 reciprocates a machining width (distance obtained by adding distances required for acceleration and deceleration to an area to be irradiated with the laser beams).

The oscillating frequency of the laser oscillator is usually 20 kHz or higher. In the aforementioned manner, the machining speed can be made 1.4 times as high as that in the case where the winding direction of the composite sheet A is set at right angles with the moving direction of the table 60. In addition, the mass of the table 60 can be made smaller than the mass of the table T. Accordingly the moving velocity can be made higher than that in the case where the table 60 is moved in the illustrated up/down direction. As a result, the machining efficiency can be improved as compared with that in the case where the table T is moved.

The table T may be designed to be moved in the illustrated up/down direction. Alternatively the table T may be designed to be mounted on a rotationally positioning mechanism so that the angle of the table T with the table 60 can be changed.

In the laser machining apparatus shown in FIG. 18, the distance between the laser oscillator 8 and the fθ lens 32 changes correspondingly to the machining width. Therefore, when a relay lens is disposed between each beam distributor 10 and each beam mode shaper 11, the laser beam diameter and the beam mode (laser intensity distribution) can be fixed. As a result, the machining quality can be made uniform.

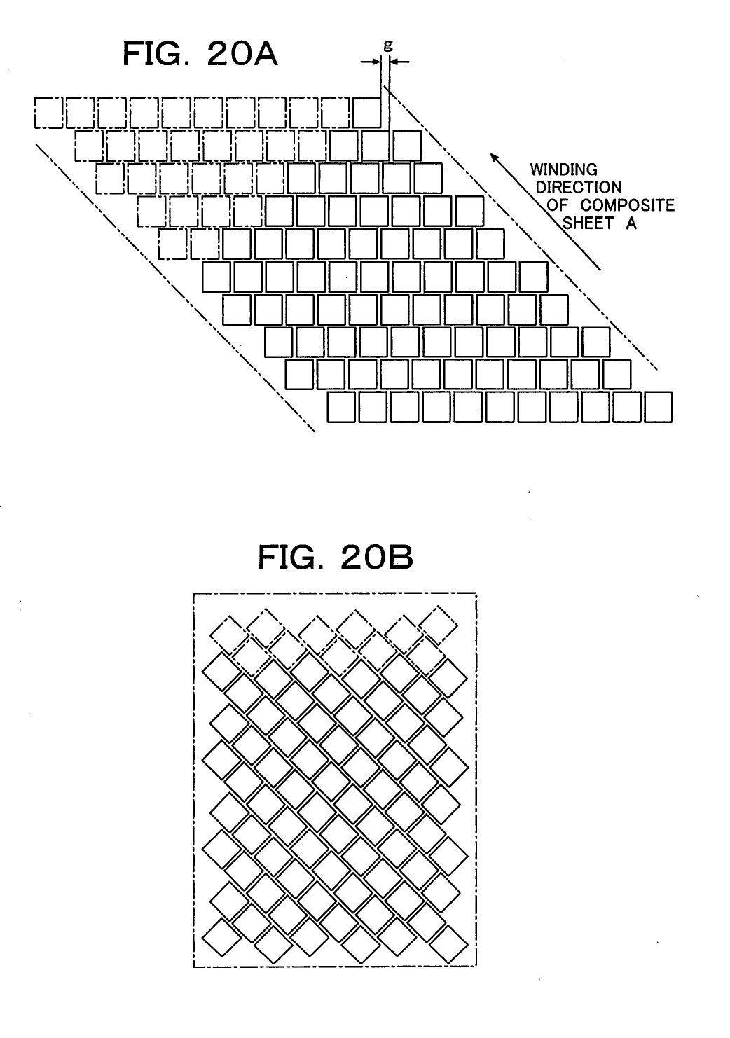

Here, as shown in FIGS. 20A and 20B, positions of windows may be shifted in the row direction between upper and lower columns if the shifted distance is within a range having no trouble in practical use (illustrated distance g).

The number of beams may be more increased.

When a hole cannot be machined out by one pulse, for example, in FIG. 18 the number of times of reciprocating of the table 60 may be increased so that the hole can be machined out by a plurality of pulses.

Further, for example, a diffraction-type or aspherical beam shaper or the like may be used to shape the outer shape of a laser beam, for example, into a shape similar to and slightly larger than a beam shape serving for irradiation, and shape the shaped beam into a final shape by use of a mask. In this manner, the use efficiency of the beam can be improved.

Description has been made about the case where a composite sheet is machined. When a plate-like composite

Description has been made about the case where windows are formed in a composite sheet. However, a laser machining apparatus according to the present invention can be also applied to the case where places scattered regularly on the sheet to be heated, such as the case in the step of forming organic transistors in the flat panel.

1. A composite sheet comprising a first layer and a second layer serving as base layers and put on top of each other in a thickness direction thereof, wherein holes having one and the same triangular, quadrangular or hexagonal outer shape and having one and the same size are disposed in the second layer so that distances between sides of adjacent ones of the holes are equal to one another.

2. A composite sheet according to claim 1, wherein the first layer is made of an organic compound layer, and the second layer is made of a metal conductor layer.

3. A composite sheet according to claim 1, wherein the first layer is made of a glass layer, and the first layer is coated with the second layer which is acrylic resin or epoxy resin mixed with powder of titanium or carbon.

4. A composite sheet according to claim 1, wherein sides and interior angles of the holes having one and the same shape are equal to those of one another.

5. A composite sheet according to claim 1, wherein an open area ratio (the open area ratio is expressed by dividing the area of a hole by the area of a figure including dimensions of the hole margined with ½ of a distance to an adjacent hole) of the holes is not lower than 90%.

6. A composite sheet according to claim 1, wherein a pitch of the holes is not longer than 300 μm.

7. A composite sheet according to claim 2, wherein the metal conductor layer is not thicker than 3 μm.

8. A composite sheet according to claim 2, wherein the organic compound layer is made of PET, and the organic compound layer is not thicker than 100 μm.

9. A machining method for a composite sheet including a first layer and a second layer serving as base layers and put on top of each other in a thickness direction thereof, comprising the step of:
machining the second layer with a laser beam so that holes having one and the same triangular, quadrangular or hexagonal outer shape and having one and the same size are disposed in the second layer so that distances between sides of adjacent ones of the holes are equal to one another.

10. A machining method for a composite sheet according to claim 9, wherein the first layer is made of an organic compound layer, and the second layer is made of a metal conductor layer.

11. A machining method for a composite sheet according to claim 9, wherein the first layer is made of a glass layer, and the first layer is coated with the second layer which is acrylic resin or epoxy resin mixed with powder of titanium or carbon.

12. A machining method for a composite sheet according to claim 9, wherein energy density of the laser beam with which the second layer is irradiated is made not higher than 0.4 J/cm².

13. A laser machining apparatus comprising:
a laser oscillator which outputs a pulsed laser beam at a frequency f;
a mask which shapes an outer shape of the laser beam into one of a triangle, a quadrangle and a hexagon;
N pieces of time-sharing means which time-share the laser beam so as to form N laser beams each having a frequency of f/N;
N pairs of positioning means which position the time-shared laser beams;
a condensing lens which condenses the laser beams;
a displacement means for displacing a laser irradiation portion in which the positioning means for the laser beams and the condensing lens are disposed, or a workpiece; and
a control means for controlling the time-sharing means, the positioning means and the displacement means; wherein the control means makes control:
to position the N pairs of positioning means so as to irradiate predetermined positions with the laser beams, and to thereafter operate the displacement means;
to thereupon operate the time-sharing means in predetermined order; and
to machine the workpiece to make holes whose outer shapes depend on the mask, so that distances between sides of adjacent ones of the holes are equal to one another.

14. A laser machining apparatus according to claim 13, wherein the N laser beams are positioned to be disposed in a straight line, while the workpiece is positioned so that a pitch of the holes becomes the shortest with respect to the straight line.

15. A laser machining apparatus according to claim 13 or 14, wherein the displacement means for the workpiece is a rotating drum.

16. A laser machining apparatus according to claim 13, wherein the displacement means displaces the laser irradiation portion relatively to the workpiece.
